(19) United States
(12) Patent Application Publication
(10) Pub. No.: US 2013/0008858 A1
(43) Pub. Date: Jan. 10, 2013

(54) Systems and Methods for Process Stream Treatment

(76) Inventors: Michael Howdeshell, Ringle, WI (US); Clayton B. Maugans, Wausau, WI (US); Chad L. Felch, Mosinee, WI (US); Evgeniya Freydina, Acton, MA (US); Li-Shiang Liang, Harvard, MA (US); Joseph D. Gifford, Marlborough, MA (US)

(21) Appl. No.: 12/520,001

(22) PCT Filed: Dec. 21, 2007
(86) PCT No.: PCT/US07/26219

§ 371 Date: Dec. 8, 2009

Related U.S. Application Data
(60) Provisional application No. 60/871,496, filed on Dec. 22, 2006.

(51) Int. Cl. C02F 9/14; C02F 9/06; C02F 1/72

(52) U.S. Cl. 210/758; 210/202; 210/143

(57) ABSTRACT

Systems and methods for process stream treatment. The treatment system may generally include an oxidation unit coupled to a downstream demineralization unit. The oxidation unit may oxidize organic and reduced sulfur contaminants in the process stream to facilitate downstream treatment. The demineralization unit may convert a product of the oxidation unit to generate a mineral stream. In some examples, the process stream may be a spent caustic stream from an industrial operation, such as an ethylene production facility or a petroleum refinery. A fresh caustic stream, such as a sodium hydroxide stream, may be isolated in the demineralization step and returned to the industrial operation for use.

### FIELD OF THE TECHNOLOGY

The present invention relates generally to process stream treatment and, more particularly, to systems and methods for the demineralization thereof.

### BACKGROUND

Oxidation is a well-known technology for treating process streams, and is widely used, for example, to destroy pollutants in wastewater. Wet oxidation, for example, involves aqueous phase oxidation of undesirable constituents by an oxidizing agent, generally molecular oxygen from an oxygen-containing gas, at elevated temperatures and pressures. The process can convert organic contaminants to carbon dioxide, water and biodegradable short chain organic acids, such as acetic acid. Inorganic constituents including sulfides and mercaptides can also be oxidized; cyanides can be hydrolized. As an alternative to incineration, wet oxidation may be used in a wide variety of applications to treat process streams, such as for subsequent discharge.

Various ion recovery methods are also commonly known. One technique involves continuous electrodeionization (CEDI) systems which are used almost exclusively for the production of ultrapure water from streams that are already substantially deionized. CEDI feeds are typically reverse osmosis treated streams. The CEDI feed and product streams have low conductivities and therefore the cells are usually filled with a resin in order to increase conductivity of the matrix. The cells are arranged in alternating pairs, with each pair generally producing one ultrapure water stream and one brackish reject stream. The capacity of a CEDI module is dictated by how many cell pairs are included between the electrodes at the ends of the module. Typically, around 30-120 cell pairs are used per module for a commercial scale application. The housing of the CEDI module is configured with ducting that collects the product water in one stream and the ionic reject stream in another. Commercial applications are typically in the range of 10 amps or less.

### SUMMARY

Aspects relate generally to systems and methods for process stream treatment.

In accordance with one or more aspects, a system for treating an aqueous feed comprises an oxidation unit fluidly connected to a source of the aqueous feed, and a demineralization unit fluidly connected downstream of the oxidation unit, constructed and arranged to convert a product of the oxidation unit to a target compound.

In accordance with one or more aspects, a system for treating an aqueous feed containing a spent caustic comprises an oxidation unit fluidly connected to a source of the aqueous feed, and an electrochemical deionization unit fluidly connected downstream of the oxidation unit, constructed and arranged to generate a fresh caustic.

In accordance with one or more aspects, a method of treating an aqueous stream comprises oxidizing the aqueous stream to form an oxidation product, and converting the oxidation product to form a caustic stream.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures. In the figures, which are not intended to be drawn to scale, each identical or nearly identical component that is illustrated in various figures is represented by a like numeral. For purposes of clarity, not every component may be labeled in every drawing. The figures are provided for the purposes of illustration and explanation and are not intended as a definition of the limits of the invention. In the figures:

FIG. 1 illustrates a treatment system in accordance with one or more embodiments;

FIG. 2 illustrates a caustic stream treatment system in accordance with one or more embodiments;

FIG. 3 illustrates operation of a continuous electrodeionization unit in accordance with one or more embodiments;

FIGS. 4A-4E illustrate various system plumbing configurations as discussed in an accompanying Example;

FIGS. 5A and 5B present tables summarizing test conditions and results as discussed in an accompanying Example;

FIGS. 6A-6E present CEDI module power charts as discussed in an accompanying Example;

FIGS. 7A and 7B present data relating to effect of electrical current as discussed in an accompanying Example;

FIGS. 8A-8D present mass balances for several different system configurations in accordance with one or more embodiments; and

FIG. 9 illustrates determined strength of NaOH in CEDI product stream necessary to satisfy mass balance needs in accordance with one or more embodiments.

### DETAILED DESCRIPTION

One or more embodiments relates generally to the treatment of process streams. The systems and methods may be generally effective in treating process streams contaminated with one or more readily oxidizable compounds. The systems and methods described herein may be implemented in a wide variety of applications in which it may be desirable to demineralize a process stream to facilitate downstream processing and/or to generate a product, such as a mineral stream. Beneficially, some embodiments may be particularly useful in reducing an amount of new, fresh or make-up reactant needed to be supplied to an upstream industrial application. For example, certain embodiments may treat a spent caustic feed to form a fresh caustic stream, such as a sodium hydroxide stream, of sufficient strength and quality to be returned to an upstream ethylene production facility or petroleum refinery for use as a reactant. Systems and methods may also be useful in producing a system effluent with an adjusted pH level relative to that of the initial process stream such that less pH correction, for example via chemical addition, is required for neutralization prior to discharge. Embodiments may also make efficient use of equipment, such as both oxidation and demineralization treatment units, recognizing synergy therebetween to provide substantial advantages to both equipment suppliers and end users.

It is to be appreciated that embodiments of the systems and methods discussed herein are not limited in application to the details of construction and the arrangement of components set forth in the following description or illustrated in the accompanying drawings. The systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

In accordance with one or more embodiments, a system may be fluidly connected to a source of a process stream to be treated. The process stream may be any process stream generally deliverable to the system for treatment. In some embodiments, the process stream may be an aqueous feed. In at least one embodiment, the process stream may be a wastewater stream. The process stream may be moved through the system by an operation upstream or downstream of the system. A source of an aqueous mixture to be treated by the system, such as a slurry or other feed, may take the form of direct piping from a plant or intermediate holding vessel. After treatment, the process stream may be returned to an upstream process or may exit the system as waste.

In typical operation, the disclosed systems may receive process streams from community, industrial or residential sources. In some embodiments, process streams may originate, for example, from food processing plants, chemical processing facilities, gasification projects, or pulp and paper plants. In at least one embodiment, the process stream may be an aqueous feed from a process generally relating to polyolephins, such as an ethylene plant operation, or a petroleum refinery. For example, the aqueous feed may be a spent caustic feed in some embodiments.

In accordance with one or more embodiments, the process stream may contain dissolved solids, such as minerals. In some embodiments, the minerals may have a value as a product stream if they can be separated or converted, as discussed in greater detail below. In other embodiments, minerals can be considered contaminants, making the process stream unsatisfactory for usage, treatment or disposal. Thus, it may be desirable to demineralize the process stream to extract a product and/or to ease downstream processing. Various other components may be present in the process stream including, for example only, chloride, sodium hydroxide, sodium carbonate, total organic carbon (TOC) and iron.

In accordance with one or more embodiments, a process stream may contain one or more target ions. Isolation and conversion of the target ions may be desirable as discussed herein. For example, the target ions in the process stream may be manipulated by the system to form a product stream of value or otherwise desirable. In some embodiments, the target ions may be present in the process stream as reactant byproducts due to upstream consumption of a consumable or reactant. In some embodiments, the system may isolate target ions and use them to form or generate a target compound. Thus, the target ions present in the process stream may be precursors of a target compound. For example, the target compound to be generated may be the original consumable or reactant which gave rise to the target ion in the process stream upstream of the system. The target compound may then be supplied upstream of the system for reuse. In some embodiments, the target compound may be a caustic compound, such as sodium hydroxide or ammonium sulfate. Systems and methods may generally result in a product stream containing the target compound. In at least one embodiment, the process stream may be a spent caustic stream from an industrial caustic tower, or MEROX® type treatment process, such as one used in a petroleum refinery or ethylene production facility. The spent caustic stream may typically include one or more reaction byproducts due to the consumption of fresh caustic in the caustic tower. In accordance with one or more embodiments, a reaction byproduct may generally include a target ion. For example, sodium sulfide as a reaction byproduct may include targeted sodium ions of interest. The target ion may then be converted to form a target compound by the system. For example, sodium target ions may be converted to form a sodium hydroxide target compound. The system may output a product stream containing sodium hydroxide in solution. The spent caustic stream to be treated may also include other compounds, including any residual fresh caustic. It may be desirable to generate a fresh caustic stream from the spent caustic stream for delivery back to the caustic tower.

In accordance with one or more embodiments, the process stream to be treated typically includes at least one undesirable constituent. The undesirable constituent may be any material or compound targeted to be removed from the aqueous mixture, such as for public health, process design and/or aesthetic considerations. For example, an undesirable constituent may be toxic. In some embodiments, an undesirable constituent may tend to interfere with downstream operations, such as with membranes of a downstream separation or ion recovery unit. For example, an undesirable constituent may be generally characterized as contributing to a high chemical oxygen demand (COD) level of the process stream which may have negative consequences. In at least one embodiment, an undesirable constituent in the process stream is generally capable of being oxidized. In some embodiments, the undesirable constituents capable of being oxidized are organic compounds. Certain inorganic constituents, for example, sulfides, mercaptides and cyanides can also be oxidized. In at least one embodiment, sodium sulfide may be present in the process stream. In one non-limiting embodiment, sodium sulfide may be present at a concentration of up to at least about 25,000 ppm as S.

In accordance with one or more embodiments of the present invention, a treatment system may include a first treatment unit. In some embodiments, the first treatment unit may generally act upon the process stream to facilitate further processing thereof. For example, the first treatment unit may be effective in disrupting one or more specific chemical bonds in an undesirable constituent or degradation product(s) thereof. In accordance with one or more embodiments, the first treatment unit may generally treat oxidizable contaminants, such as those contributing to COD which may hamper the effectiveness, longevity and/or appropriateness of a downstream treatment, such as a demineralization step. Thus, the first treatment unit may reduce the concentration or alter the nature of one or more undesirable constituents, such as by removing or stabilizing COD. For example, the first treatment unit may destroy or remove organic and reduced sulfur contaminants. In some embodiments, the first treatment unit may also generally put at least one target ion in a different or preferred form for downstream extraction as discussed herein. In at least one embodiment, the first treatment unit may generally be included as a pretreatment step prior to a demineralization step as discussed in greater detail below.

In accordance with one or more embodiments, the first treatment unit or stage may be an oxidation unit. An oxidation reaction is one destruction technique, capable of converting oxidizable organic contaminants to carbon dioxide, water and biodegradable short chain organic acids, such as acetic acid. One aspect of the present invention involves systems and methods for oxidative treatment of aqueous mixtures containing one or more undesirable constituents. An oxidation unit may oxidize sulfides to form non-toxic sulfate ions and oxidize other species also present in the process stream, such as a spent caustic stream. Mercaptans may be rendered substantially innocuous, and COD contaminants may be converted into stable compounds which are less detrimental to downstream operations. Because 100% oxidation may not be achieved, some undesirable constituents may still be present in an oxidation product of the oxidation unit. Residual target compounds, such as sodium hydroxide and sodium carbonate, may also be present in the oxidation product. In some non-limiting embodiments, typical oxidation products may include sodium carbonate and sodium sulfate. Mineralized products may be formed, such as sulfate and carbonate ions. In at least some embodiments, at least one salt of a target ion, such as sodium, may be formed by the oxidation process. For example, sodium may form salt complexes with oxidized ions. Thus, an oxidation product may include target ions, such as sodium, present in a different form than in the original process stream. For example, in some embodiments sodium may generally be present as sodium sulfide upstream of the oxidation unit, but may exit the oxidation unit in sodium sulfate and/or sodium carbonate.

In accordance with one or more embodiments, any oxidizer may be used in the oxidation unit. For example, any source of oxygen, such as oxygen gas, ozone, peroxide and permanganate, or combinations thereof may be used. Likewise, any oxidation technique or technology, or combination thereof may be used. For example, in some embodiments, photo-oxidation techniques may be used in which conversion of a reduced molecule to an oxidized form in the presence of oxygen is generally conducted via a set of chemical reactions that are initiated by photolysis. In at least one embodiment, for example, UV or visible light may be employed. In accordance with one or more embodiments, the oxidation unit may generally be a liquid phase oxidation unit. In at least one embodiment, the liquid phase oxidation unit may be a wet oxidation unit, such as a wet air oxidation, wet peroxide oxidation or supercritical water oxidation unit.

In one embodiment, for example, an aqueous mixture or process stream including at least one undesirable constituent is wet oxidized. The aqueous mixture is oxidized with an oxidizing agent at an elevated temperature and superatmospheric pressure for a duration sufficient to treat the at least one undesirable constituent. Non-limiting embodiments involve process temperatures above about 150° C. More specifically, the process temperature may be above about 200° C. In some embodiments, the process temperature may be above about 250° C. Likewise, the duration or residence time may vary. In some embodiments, residence times may vary from about one-half hour up to ten hours. Some non-limiting embodiments involve residence times of about one hour, but shorter or longer residence time may be employed depending on conditions of an intended application. The oxidation reaction may substantially destroy the integrity of one or more chemical bonds in the undesirable constituent. As used herein, the phrase “substantially destroy” is defined as at least about 95% destruction. The process of the present invention is generally applicable to the treatment of any undesirable constituent capable of being oxidized.

The disclosed wet oxidation processes may be performed in any known batch or continuous wet oxidation unit suitable for the compounds to be oxidized. Typically, aqueous phase oxidation is performed in a continuous flow wet oxidation system. Any oxidizing agent may be used. The oxidant is usually an oxygen-containing gas, such as air, oxygen-enriched air, or essentially pure oxygen. As used herein, the phrase “oxygen-enriched air” is defined as air having an oxygen content greater than about 21%.

In typical operation, an aqueous mixture from a source, such as a storage tank, flows through a conduit to a high pressure pump which pressurizes the aqueous mixture. The aqueous mixture is mixed with a pressurized oxygen-containing gas, supplied by a compressor, within a conduit. The aqueous mixture flows through a heat exchanger where it is heated to a temperature which may initiate the oxidation. The heated feed mixture then enters a reactor vessel at an inlet. The wet oxidation reactions are generally exothermic and the heat of reaction generated in the reactor may further raise the temperature of the mixture to a desired value. The bulk of the oxidation reaction occurs within the reactor vessel which provides a residence time sufficient to achieve the desired degree of oxidation. The oxidized aqueous mixture and oxygen depleted gas mixture then pass from the reactor to a heat exchanger. The hot oxidized effluent traverses the heat exchanger where it is cooled against incoming raw aqueous mixture and gas mixture. The cooled effluent mixture flows through a conduit controlled by a pressure control valve and into a separator vessel where liquid and gases are separated. The liquid effluent exits the separator vessel through a lower conduit while off gases are vented through an upper conduit. Treatment of the off-gas may be required in a downstream off gas treatment unit depending on its composition and the requirements for discharge to the atmosphere. The wet oxidized effluent may typically be discharged into a treatment plant, such as a biological or chemical treatment plant for polishing before discharge. The effluent may also be recycled for further processing by the wet oxidation system. In accordance with one or more embodiments of the present invention, the effluent may also be directed to a second unit operation, such as a demineralization or ion recovery unit as discussed more fully herein.

Sufficient oxygen-containing gas is typically supplied to the system to maintain residual oxygen in the wet oxidation system off gas, and the superatmospheric gas pressure is typically sufficient to maintain water in the liquid phase at the selected oxidation temperature. For example, the minimum system pressure at about 240° C. is about 33 atmospheres, the minimum pressure at about 280° C. is about 64 atmospheres, and the minimum pressure at about 373° C. is about 215 atmospheres. In one embodiment, the aqueous mixture is oxidized at a pressure of about 30 atmospheres to about 275 atmospheres. The wet oxidation process may be operated at an elevated temperature below about 374° C., the critical temperature of water. In some embodiments, the wet oxidation process may be operated at a supercritical elevated temperature. The retention time for the aqueous mixture within the reaction chamber should be generally sufficient to achieve the desired degree of oxidation. In some embodiments, the retention time is above about one hour and up to about eight hours. In at least one embodiment, the retention time is at least about 15 minutes and up to about six hours. In one embodiment, the aqueous mixture is oxidized for about 15 minutes to about four hours. In another embodiment, the aqueous mixture is oxidized for about 30 minutes to about three hours.

According to one or more embodiments, the wet oxidation process may be a catalytic wet oxidation process. The oxidation reaction in the oxidation unit may generally be mediated by a catalyst. The aqueous mixture containing at least one undesirable constituent to be treated is generally contacted with a catalyst and an oxidizing agent at an elevated temperature and superatmospheric pressure. An effective amount of catalyst may be generally sufficient to increase reaction rates and/or improve the overall destruction removal efficiency of the system, including enhanced reduction of COD and/or TOC. The catalyst may also serve to lower the overall energy requirements of the wet oxidation system. Catalytic wet oxidation has emerged as an effective enhancement to traditional non-catalytic wet oxidation. Catalytic wet oxidation processes generally allow for greater destruction to be achieved at a lower temperature and pressure, and therefore a lower capital cost. An aqueous stream to be treated is mixed with an oxidizing agent and contacted with a catalyst at elevated temperatures and pressures. Heterogeneous catalysts typically reside on a bed over which the aqueous mixture is passed, or in the form of solid particulate which is blended with the aqueous mixture prior to oxidation. The catalyst may be filtered out of the oxidation effluent downstream of the wet oxidation unit for reuse.

In at least one embodiment, the catalyst may be any transition metal of groups V, VI, VII and VIII of the Periodic Table. In one embodiment, for example, the catalyst may be V, Cr, Mn, Fe, Co, Ni, Cu, Zn, Mo, Ag, or alloys or mixtures thereof. The transition metal may be elemental or present in a compound, such as a metal salt. In one embodiment, the transition metal catalyst is vanadium. In another embodiment, the transition metal catalyst is iron. In yet another embodiment, the transition metal catalyst is copper.

A catalyst may be added to the aqueous mixture at any point in the wet oxidation system. The catalyst may be mixed with the aqueous mixture. In one embodiment, the catalyst may be added to the source of the aqueous mixture feeding the wet oxidation unit, which catalyst source is fluidly connected to a storage tank. In some embodiments, the catalyst may be directly added to the wet oxidation unit. In other embodiments, the catalyst may also be supplied to the aqueous mixture prior to heating and/or pressurization.

The first treatment unit, such as an oxidation unit, may generally produce a product stream, such as an oxidation product stream. Thus, the oxidation unit may convert a process stream to an oxidation product stream. The oxidation product stream may generally be suitable for further processing, such as in an ion recovery or demineralization unit as discussed herein. The oxidation product may generally be substantially free of undesirable constituents. The oxidation product may also contain one or more target ions from the original process stream which may be subject to further manipulation as discussed herein to generate a desired product.

In accordance with one or more embodiments, a second treatment unit may be fluidly connected downstream of the first treatment unit. The second treatment unit may be configured to receive the oxidation product or oxidation product stream for further treatment. In some embodiments, the second treatment unit may generally convert an oxidation product of the first treatment unit to form a target compound or target stream. The target compound may be generally isolated by the system for extraction, and may have value as a product stream or its removal may facilitate downstream operation. In some embodiments, the second treatment unit may generally demineralize the oxidation product stream to facilitate downstream treatment and/or produce a product stream rich in valuable minerals. The second treatment unit may involve any technology generally capable of extracting ions to produce an ion-rich product stream as well as a stream with decreased mineral content. For example, the second treatment unit may be effective in conducting ion recovery of compounds including sodium, potassium, calcium, carbonate and sulfate.

In accordance with one or more embodiments, a demineralization unit may, for example, include at least one ion exchange resin bed. Ion exchange may generally involve the interchange of ions between a solution and a solid, commonly a resin, for demineralization. More specifically, ion exchange may involve reversible exchange of ions adsorbed on a mineral or synthetic polymer surface with ions in solution in contact with the surface. Target ions may be removed and replace with other ions, such as hydrogen ions. Target ions are then recovered from the exchange bed by passing water or other regeneration fluid through the bed periodically to replenish the resin with fresh hydrogen ions and produce a rinse water that contains a target compound, such as a sodium hydroxide stream.

For example, a cationic monomer may be polymerized within the structure of an anion-exchange resin, or vice versa, resulting in a polyelectrolyte structure. Regenerated, this structure may have its cationic groups in hydrogen form, and anionic groups in hydroxyl. Introduction of an electrolyte will displace the hydrogen and hydroxyl ions, causing their neutralization, saturating the resin with ionic species. Regeneration with water may cause the resin groups to hydrolyze, during which the target ion will be liberated and recovered. A lime solution may also be used to regenerate the bed to produce a target compound, such as sodium hydroxide.

In accordance with one or more embodiments, concentrating or separation operations may also be employed to effect ion recovery or demineralization. Distillation, for example, generally involves evaporation and subsequent condensation to collect vapors. Crystallization and filtration processes, such as nanofiltration, may also be implemented. Reverse osmosis processes involving a filtration process that removes dissolved salts and metallic ions from water in which applied pressure on the concentrated side forces it through a semipermeable membrane may likewise be used.

In accordance with one or more embodiments, examples of demineralization or ion removal technologies may include electrochemical operations, such as electrodialysis, electrodeionization, capacitive deionization and continuous electrodeionization (CEDI). In accordance with one or more embodiments, a demineralization unit may involve capacitive deionization, generally based on an electrostatic process operating at low voltages and pressures. Produced water is pumped through an electrode assembly. Ions in the water are attracted to the oppositely charged electrodes. This concentrates the ions at the electrodes, while reducing the concentration of the ions in the water. The cleaned water then passes through the unit. When the electrodes capacity is reached, the water flow is stopped and the polarity of the electrodes is reversed. This causes the ions to move away from the electrodes, where they had previously accumulated. The concentrated brine solution is then purged from the unit.

In accordance with one or more embodiments, a continuous electrodeionization (CEDI) process may be implemented. CEDI generally uses a combination of ion exchange resins and membranes and direct current to continuously deionize the water without the need for chemicals, CEDI is an electrochemical process where an electrical charge is applied across the module. Electrodes of electrochemical devices may generally be made of various materials, such as stainless steel, iridium oxide, ruthenium oxide and platinum. Electrodes may also be coated with various materials, for example, with titanium. The electrodes cause the formation of H⁺ and OH⁻ ions. The ions, along with the ions in the feed, are transported by the potential across the device. The module is arranged with cells separated by membranes. The cell depth is about 0.1 inch. The membranes allow only either anions or cations to pass. In this way, ionic species are concentrated in some cells, while other cells are depleted of ions. The flow of ions is directly related to the electrical current applied to the module. Electrons do not flow across a cell. The electrons form ions and it is the ions that flow across the CEDI module.

The process typically relies on the use of cells separated by ionic membranes. The conductivity of pure water is very low, so the required voltage to transportions through pure water is very high. Resins are used to increase conductivity in the water cells, which decreases the voltage requirement. The resins are about 0.3 to about 0.5 mm spheres. The surface of a resin has an ionic charge and is either cationic (c) or anionic (a). Cationic resins have anionic functional groups, which attract cationic species (i.e. cationic resins are so called because they attract cations). In this way, cations can flow across the cell by traveling on the cationic resins. Similarly, anionic resins allow transport of anions. In application, many beds are mixed with both anionic and cationic resins, which allow transport of both types of ions across a cell.

The membranes are also made with cationic or anionic materials. The IonPure™ (a Siemens company) membranes are fabricated by mixing the resins with polyethylene and extruding into sheets. This is called a heterogeneous structure. The polyethylene provides the mechanical strength and the resin the transport properties. Cationic membranes only allow cations to pass while anionic membranes only allow anions to pass.

When wetted, the resins and membranes may swell. Swelling causes the resins to exert a pressure on the walls and membranes of up to about 100 psi of force. The resin material in the membrane also expands, which permanently alters the structure of a heterogeneous membrane. In clean water applications the nominal leakage rate of an IonPure™ membrane is about 20 mL/hr/ft²/5 psi. Sodium ions cause less swelling than hydronium ions. Therefore, in high strength brines the resin in the heterogeneous membrane will contract, causing the resin to become more porous. Homogeneous membranes are made of only resin, and so allow a higher current flux. They are more expensive than heterogeneous membranes but are otherwise interchangeable.

Bipolar membranes are anionic membranes on one side and cationic on the other. They are the most expensive type of membranes and are used for water splitting. These membranes can be used in the place of a water splitting cell. They rely on water diffusion into the membrane and may not be appropriate for high rate production.

A power supply drives DC electrical current through the electrodes of the device. The electrodes are the outermost cells on opposite sides of the module. The electrode cells do not contain resin, but instead use a high strength brine to provide conductivity in the cell. A plastic screen is placed in the cell to prevent the membrane from touching the electrode.

The cathode (−) is typically made from stainless steel, though other anode materials can also be used. The electrons flow from the power source through this electrode. In the cathode cell, this causes the formation of hydroxide ions and hydrogen gas.

4H₂O+4e⁻→2H₂(g)+4OH⁻

Sodium reduction to metallic sodium (plating) is an alternate route for consuming the electrons. However this does not happen because the potential requirement for sodium plating is higher than the potential necessary for the H₂(g) formation. The production rate of hydrogen is calculated from Faraday's Law, which can be written as:

$${\dot{n}}_{H 2} = 0.5 \frac{A}{F}$$

Where, \dot{n}_{H2} is the molar production rate of hydrogen gas (mole H₂/second), A is the electrical current (Amp), F is Faraday's constant (96,485 coulomb/mole).

The anode (+) is titanium coated with a corrosion resistant conductor. Conductors are typically platinum, iridium oxide, or ruthenium oxide. Iridium oxide is usually used as the coating in Siemens C-Series modules. For high amperage applications platinum may be a better material. The electrons are pulled from water in the cell and are returned to the power source. This causes the formation of oxygen gas.

2H₂O−4e⁻→O₂(g)+4H⁺

The production rate of oxygen is calculated from the below equation

$${\dot{n}}_{O2} = 0.25 \frac{A}{F} = 0.5 {\dot{n}}_{H 2}$$

Where, \dot{n}_{O2} is the molar production rate of hydrogen gas (mole O₂/second), A is the electrical current (Amp), F is Faraday's constant (96,485 coulomb/mole).

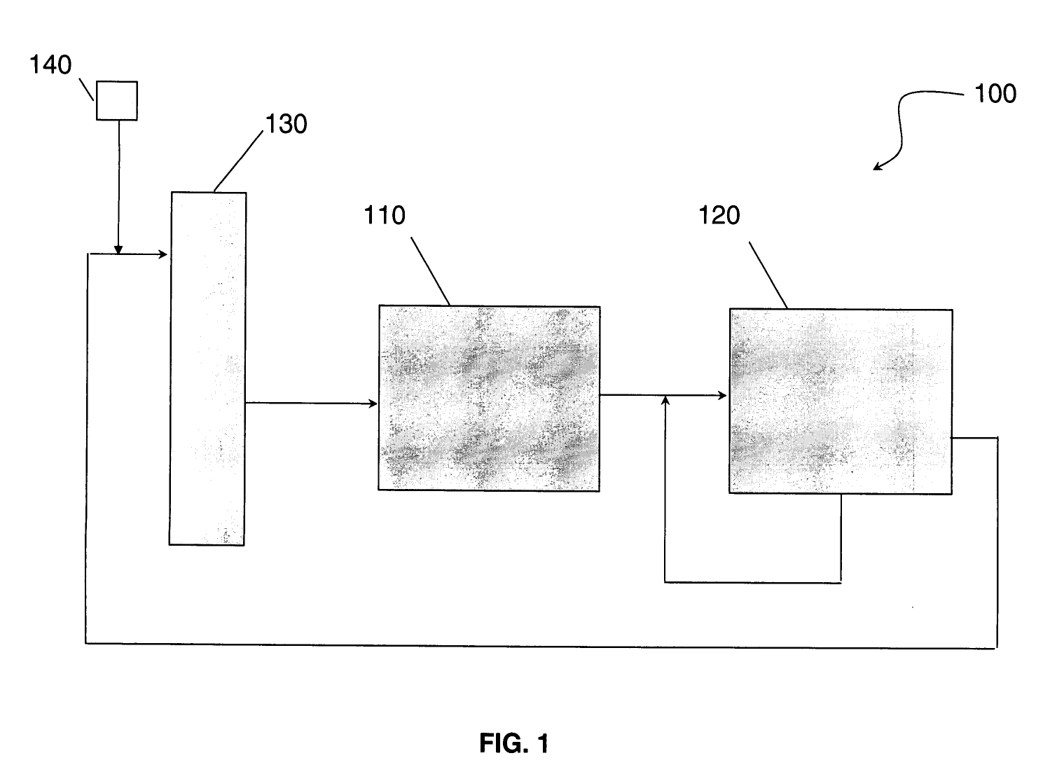

With reference to FIG. 1, operation of a treatment system 100 may involve a process stream being directed to an oxidation unit 110 from an industrial application 130. An oxidation product stream exiting the oxidation unit 110 may be directed to a demineralization unit 120. Demineralization unit 120 may produce a target compound stream, such as a sodium hydroxide stream. This stream may be directed back to the industrial application 130 for further use. The target compound stream may be introduced directly to the industrial application 130 or may be mixed upstream thereof with fresh reactant from reactant source 140. A discharge stream may be recycled back to the demineralization unit 120 for further processing and/or extraction of the target compound. Thus, less fresh reactant may need to be added to industrial application 130 due to the production of reactant by the system from the process stream.

In one aspect, spent caustic may be treated to recover a sodium hydroxide product stream. An ethylene plant or petroleum refinery plant may use fresh caustic, such as sodium hydroxide, to remove or scrub acid gases such as carbon dioxide and hydrogen sulfide from a process gas. The fresh caustic may be about 50% NaOH in water, typically diluted to about 10% for use in the caustic tower. As much as about 8 tons of fresh caustic per hour may be consumed. The caustic tower may also condense organic species such as mercaptans, light hydrocarbosn, acetaldehyde, and naphthenic and cresylic acids. As more acid is scrubbed, the amount of free caustic is reduced until it is no longer useful. At this point, the plants will typically remove the caustic from the system and it becomes known as spent caustic.

Typical spent caustic streams contain sodium carbonate, sulfides and high weight organic compounds dissolved in the solution. The stream may typically have a high pH which retains the sulfide, carbonate, and organic acids in the liquid phase. The stream may have a high content of dissolved solids, but is generally unsuitable for many demineralization processes because reactive sulfides and organic compounds may not be compatible with demineralaition processes, such as membrane materials of a CEDI system. Removal of the cations, such as sodium, would cause a release of the sulfide from the liquor, which in many cases is undesirable since hydrogen sulfide is a corrosive gas that is highly odorous and toxic.

The spent caustic liquor is oxidized using WAO and then demineralized using CEDI. The oxidation converts the sulfides to harmless sulfate and the organic compounds to carbonate and short chain organic acids which are relatively stable and less disruptive to demineralization processes. The oxidized liquor then passes to a CEDI process which removes a portion of the sodium to produce a sodium hydroxide product stream. The residual stream is somewhat demineralized by the removal of the sodium ions, which also decreases the effluent pH.

One or more additional unit operations may be fluidly connected downstream of the demineralization unit. For example, a concentrator may be configured to receive and concentrate a target product stream, such as before delivering it upstream to an industrial operation for use. Polishing units, such as those involving chemical or biological treatment, may also be present to treat an effluent stream of the system prior to discharge.

In accordance with one or more embodiments, disclosed systems may operate continuously or intermittently. In some embodiments, the wet oxidation system may include a controller for adjusting or regulating at least one operating parameter of the system or a component of the system, such as, but not limited to, actuating valves and pumps. Controller may be in electronic communication with at least one sensor configured to detect at least one operational parameter of the system. The controller may be generally configured to generate a control signal to adjust one or more operational parameters in response to a signal generated by a sensor.

The controller is typically a microprocessor-based device, such as a programmable logic controller (PLC) or a distributed control system, that receives or sends input and output signals to and from components of the wet oxidation system. Communication networks may permit any sensor or signal-generating device to be located at a significant distance from the controller or an associated computer system, while still providing data therebetween. Such communication mechanisms may be effected by utilizing any suitable technique including but not limited to those utilizing wireless protocols.

Operating economics will include operator time, clean water, electrical power for mechanical and instrumentation, and electrical power for providing the amperage to the CEDI electrodes. The electrical costs for operating CEDI depend on the resistances and on the extent of membrane leaking that the sodium will have back into brine cells. Economic benefit from operating CEDI may be the production of valuable NaOH. In addition, in conventional WAO spent caustic applications, neutralization acid must be purchased to neutralize the alkalinity of the oxidized spent caustic. Since some of that alkalinity is being removed with CEDI, there may be additional savings in neutralization acid consumption.

The function and advantages of these and other embodiments will be more fully understood from the following examples. These examples are intended to be illustrative in nature and are not to be considered as limiting the scope of the embodiments discussed herein.

### Example

Laboratory tests were performed using standard and modified versions of a Siemens C-Series CEDI module. The goals of the evaluation work were to determine the efficacy of the CEDI process for producing a NaOH product stream from a synthetic mixture of inorganic salts, determine the maximum strength of NaOH product that can be produced—with the intention of reaching up to 18 g/L NaOH, and to evaluate the economics of this application to the cost of purchasing commercial NaOH. The tests were reported during 3 test periods.

### I. Experimental Design

A. Tests 1-13

Tests 1-13 were performed in a Siemens C-Series CEDI module. The components are described below.
Aluminum endplate—cathode endplate.
Cathode electrode—made from iridium.
A screen, which was used to make cell type S.
A cationic membrane.
Cell type 1, which was a plastic frame filled with a 60/40 v/v mix of cationic and anionic resins. The cross section profile of a cell (normal to the flow of current) consists of 3 cells in parallel. The two outer chambers are 14″×1.3125″ and the central chamber is 14″×1.25″. The total cross sectional area in a cell is 54.25″² (350 cm²).
An anionic membrane.
Cell type 2, also filled with a 60/40 v/v mix of cationic resin (The same frame is used, but inverted to direct flow to a different duct system).
A cationic membrane.
Cell type S.
A cationic membrane
Cell type 1
An anionic membrane
Cell type 2
A cationic membrane
Cell type S
Anode electrode—also made from iridium.
Aluminum endplate—anode endplate.

Each cell had one of three feed duct options and one of three discharge duct options:
Cell type S was ducted to feed brine and to discharge treated brine. H₂, O₂, and CO₂ gasses evolved in these cells, so those gasses also exited with this stream.
Cell type 1 was ducted to feed DI water and to discharge DI water.
Cell type 2 was ducted to feed DI water and to discharge NaOH product. In some cases the feed to cell type was recycled NaOH product, instead of pure DI water.

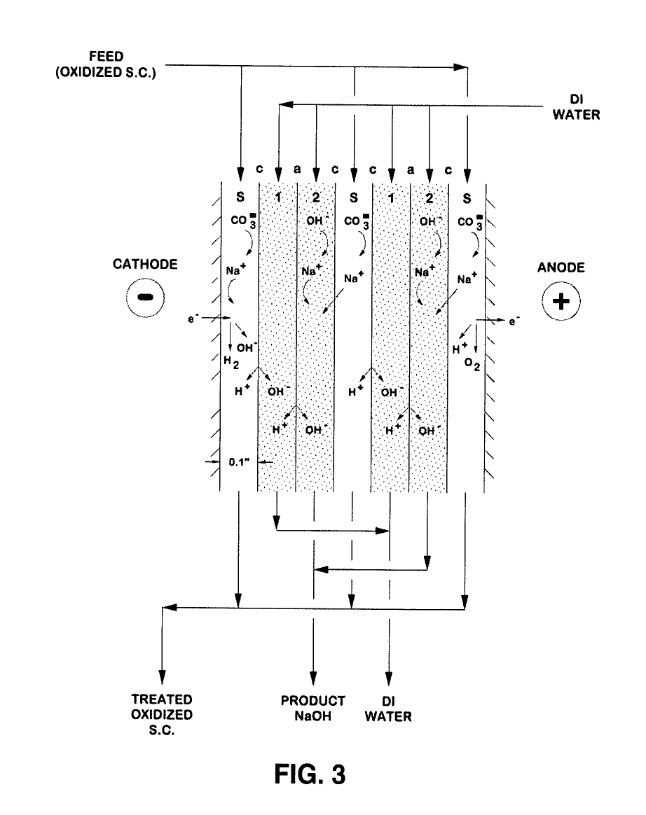

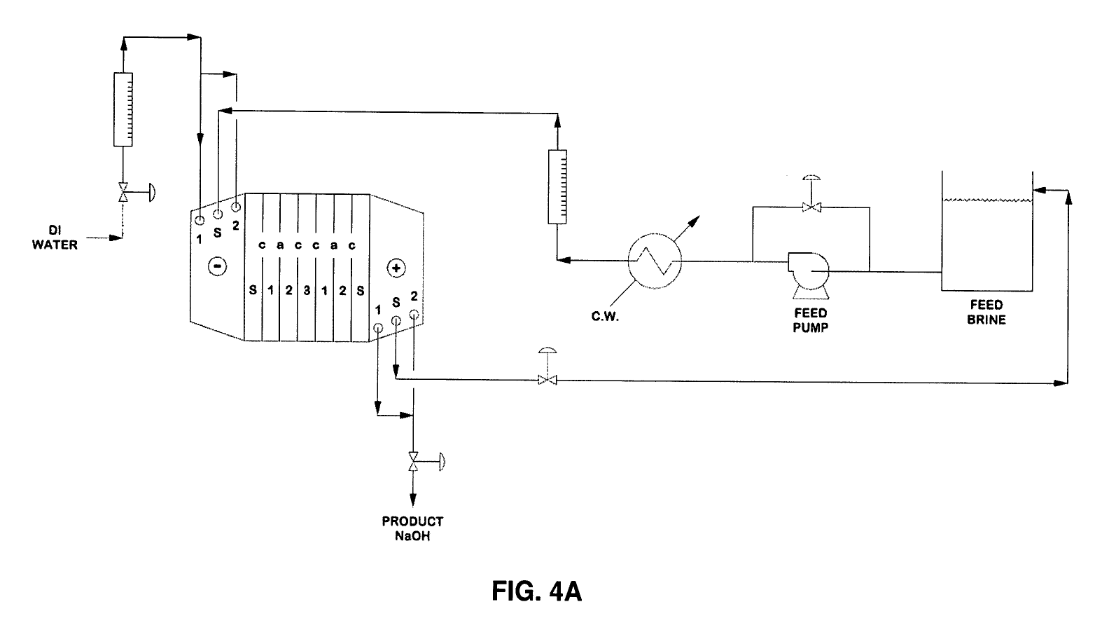

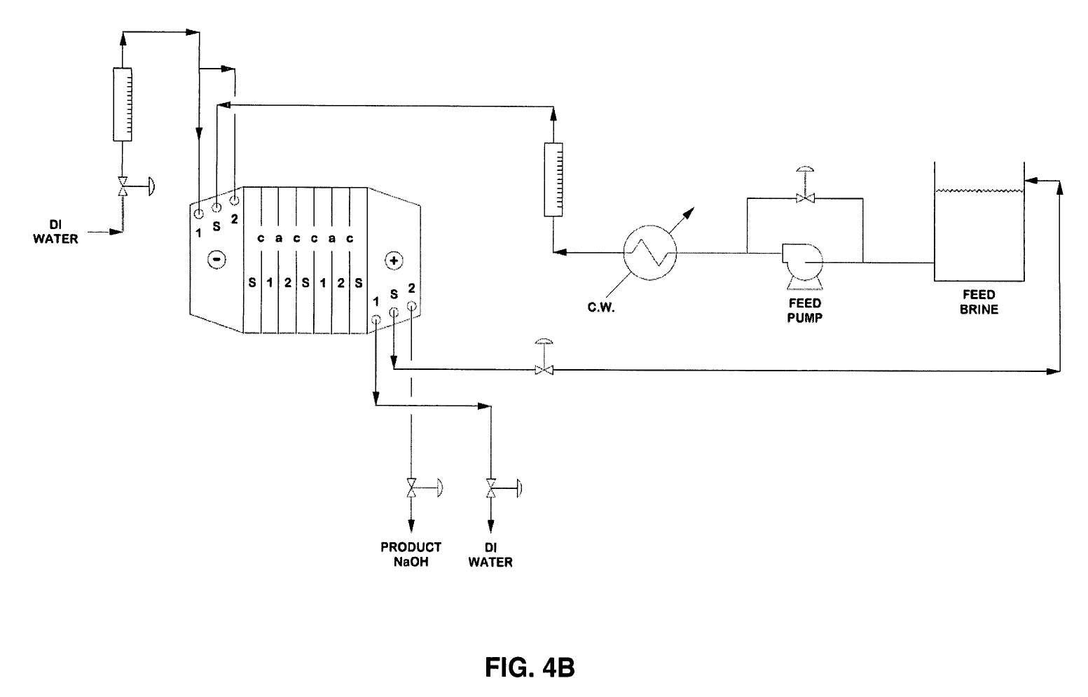

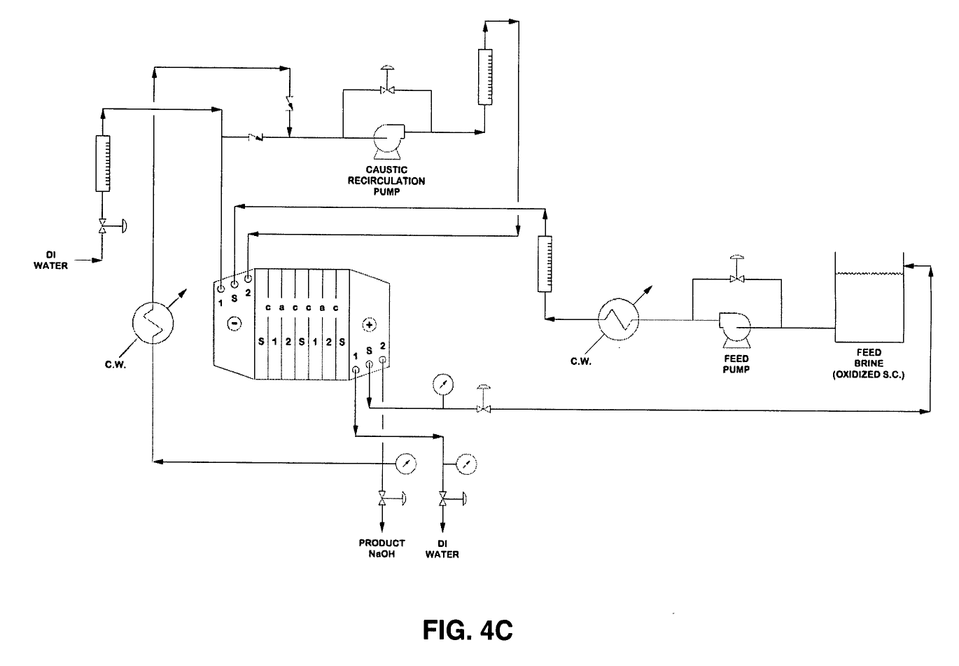

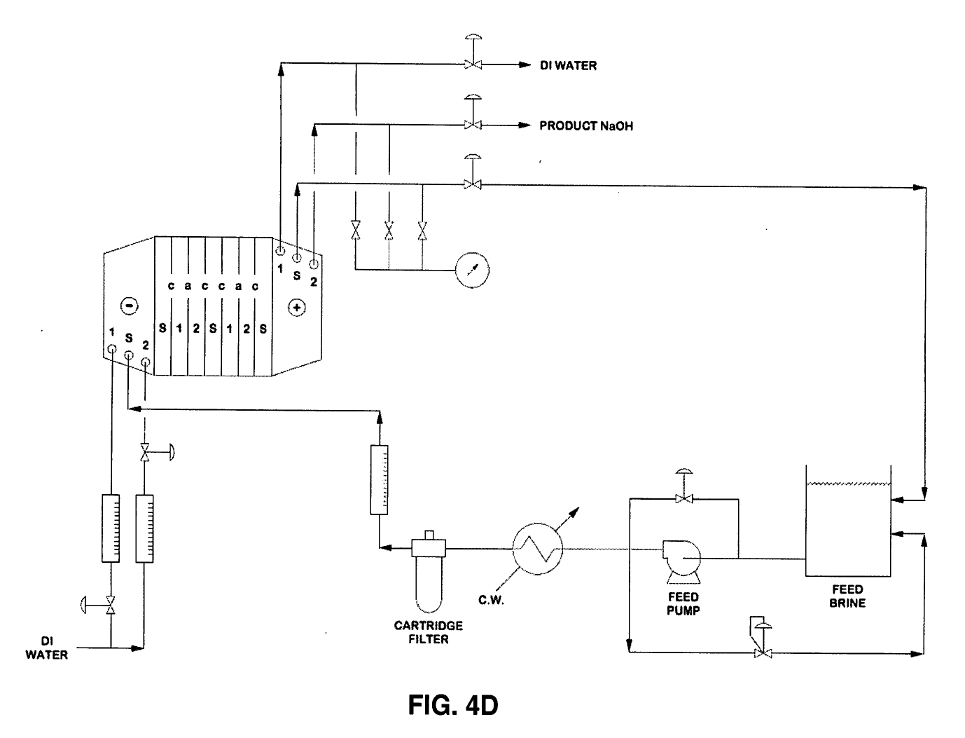

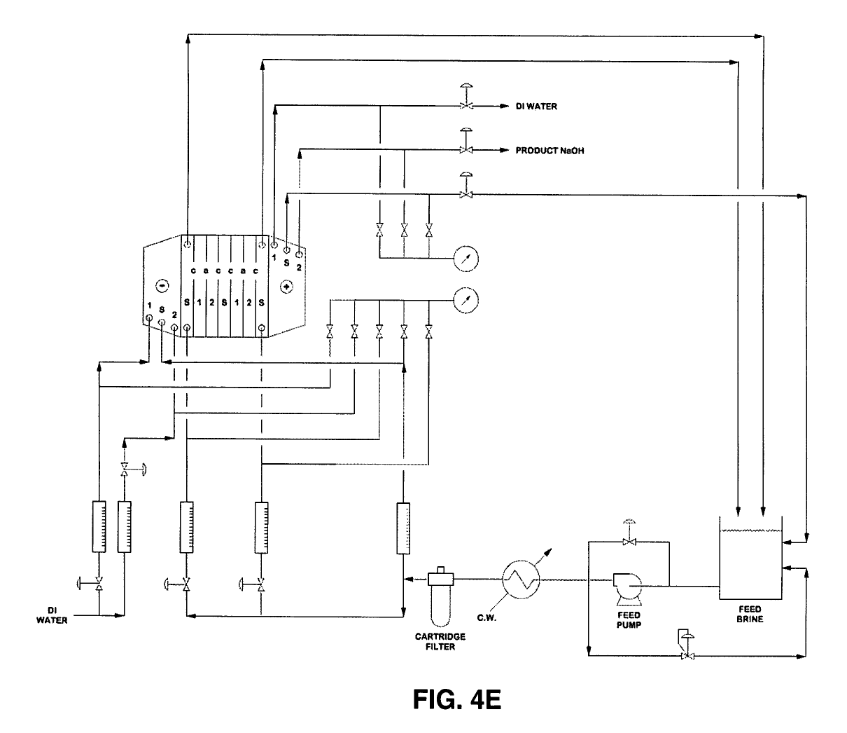

The notation for representing the cell arrangement is: −S12S12S+. The notation for representing the membrane arrangement is −caccac+. In some tests the polarity was reversed, in which case the module becomes +S21S21S−. A schematic representing the operation of the module is shown in FIG. 3. Three different plumbing configurations were evaluated, shown in FIGS. 4A-4C, respectively.

Electrical power to the module was provided by a DC power supply and a power controller. The power controller regulated the amperage to the module. The controller displayed voltage and amperage. Wiring was done by connecting the negative (black) wire into the cathode tab and the positive (red) wire into the anode tab. The electrical system was capable of delivering no more than 8 or 9 amperes of power, above which the circuit breakers would trip. The wires were 18 gauge and became warm to the touch after a few moments of operation.

Feed flow rates were monitored by the rotameters and effluent flow rates were monitored by use of a cylinder and stopwatch. pH, gas formation rate, and gas composition was not monitored. Formed gases were returned with the recycle brine to the feed tank and were vented by placing a vent hose near the feed tank.

B. Tests 14-17

The plumbing configuration for these tests is shown in FIG. 4D. The equipment was similar to that described in the prior tests, with the following exceptions:
A stronger power supply and electrical cables were used. This supply was connected to a 220 VAC 30A outlet. 8 gauge wiring was used, and these wires remained cool to the touch for all tests. Unlike the prior supply, this one delivered constant voltage, and the resulting amperage was displayed.
New electrodes capable of high current service. The electrode plates had heavy titanium terminal tabs and platinum coated electrodes.
One of the cells used a homogeneous membrane, rather than the conventional IonPure™ heterogeneous membrane.

C. Tests 50-57

Tests 50-57 were conducted with the plumbing configuration shown in FIG. 4E. The equipment was similar to that described in the prior tests, with the following exceptions:
New electrode plates were used with titanium mesh electrode plates and built in brine flow ports.
In the prior tests the brine flow to the anode, cathode, and the central screen cell were not independently controllable. To assure that no cells were being bypassed, the module was modified for tests 50-57 by independently controlling each of these streams.
The weave of the screens in the brine cells were arranged diagonal to the fluid flow, rather than parallel and perpendicular. This was done in an attempt to minimize suspected vapor locking in the screens.

### II. Description of Test Procedures

For each experimental run, the feed tank was first filled with the brine. The DI water flow was turned on and the flow adjusted using the rotameter needle valve. The main power was then turned on, which turned on the pumps. Flow rates and system back-pressures were adjusted using the various control valves. The DC power controller was energized and adjusted to the test amperage or voltage. The conductivity and temperature of the feed and each effluent was measured and recorded using an ULTRAMETER 6P II conductivity meter commercially available from Myron L Co. The system was allowed to stabilize for a number of minutes. Stabilization was monitored by using the conductivity meter. The amperage and voltage was recorded, and samples of the feed, product NaOH and product brine were collected. For some studies, multiple samples were collected over a period of time. The module was shut down by turning off the power and stopping the fresh DI water flow.

H₂ and O₂ gases are produced as bubbles in the brine. The lower explosion limit (LEL) for H₂ is 4%. Fire and explosion hazards were mitigated by venting the brine return lines into a fume hood. For a hypothetical 40A full-scale unit, 3 SCFM of air is estimated to be sufficient to dilute the H₂ to below 10% of the LEL. No LEL measurements were collected in this test work.

For tests 3-13, the feed and product samples were analyzed by HACH titration method #8203. The titration was used to measure the NaOH, Na₂CO₃ and NaHCO₃ content. The Na₂SO₄ concentration was measured by photometry using HACH method #8051.

For tests 14-57, the pH was monitored using the Myron L Co ULTRAMETER. The NaOH, Na₂CO₃, and NaHCO₃ contents were monitored by titration using a Metohm 785 DMP Titrino autotitrator.

At the conclusion of test 57, the CEDI membranes were analyzed using a ISI ABT WB-6 scanning electron microscope.

### III. Feed Description

The feed composition was based on the likely content of an oxidized spent caustic.
55 g/L Na₂SO₄
3.1 g/L Na₂CO₃
35 g/L NaHCO₃

All chemicals were reagent grade compounds purchased from Sigma-Aldrich of St. Louis, Mo. DI water was used as the solvent. Tests 11 and 12 used a higher strength feed than listed above, which was prepared by doubling the salts dose and decanting the saturated supernatant from the mix tank. Test 13 used a ¼ strength feed. Tests 50-57 were performed using a solution of 80 g/L Na₂CO₃.

In most cases the feed was recirculated through the CEDI module and back into the feed tank. So the feed sodium concentration was not constant.

### IV. Test Results

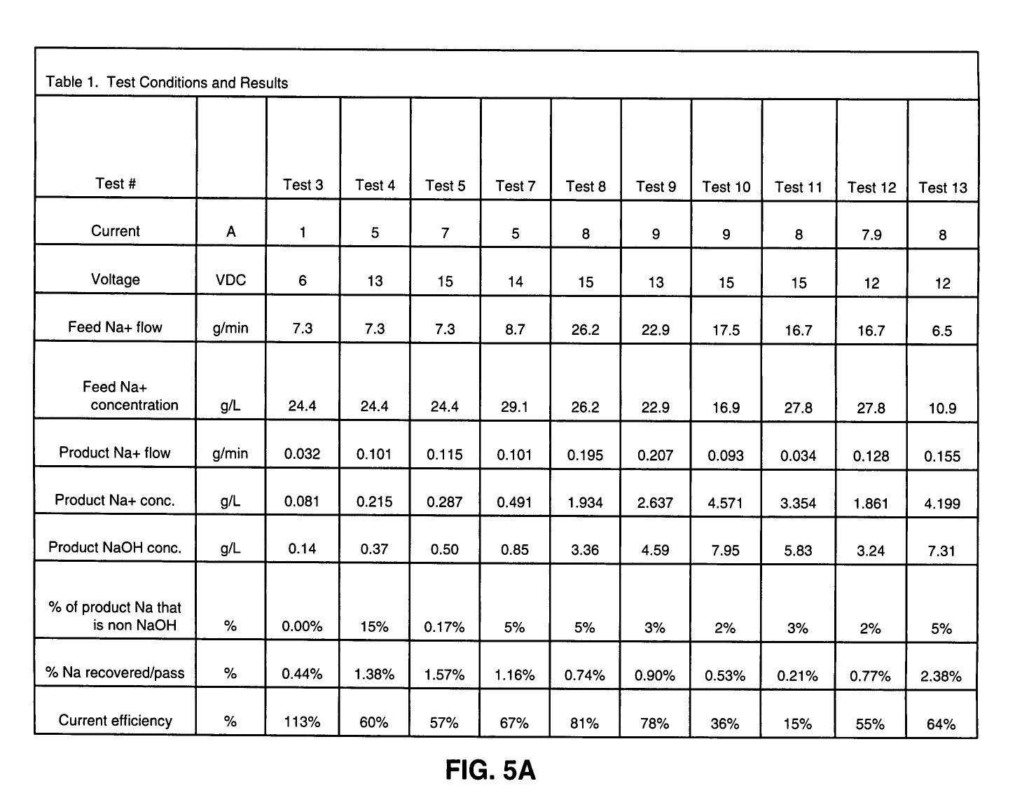

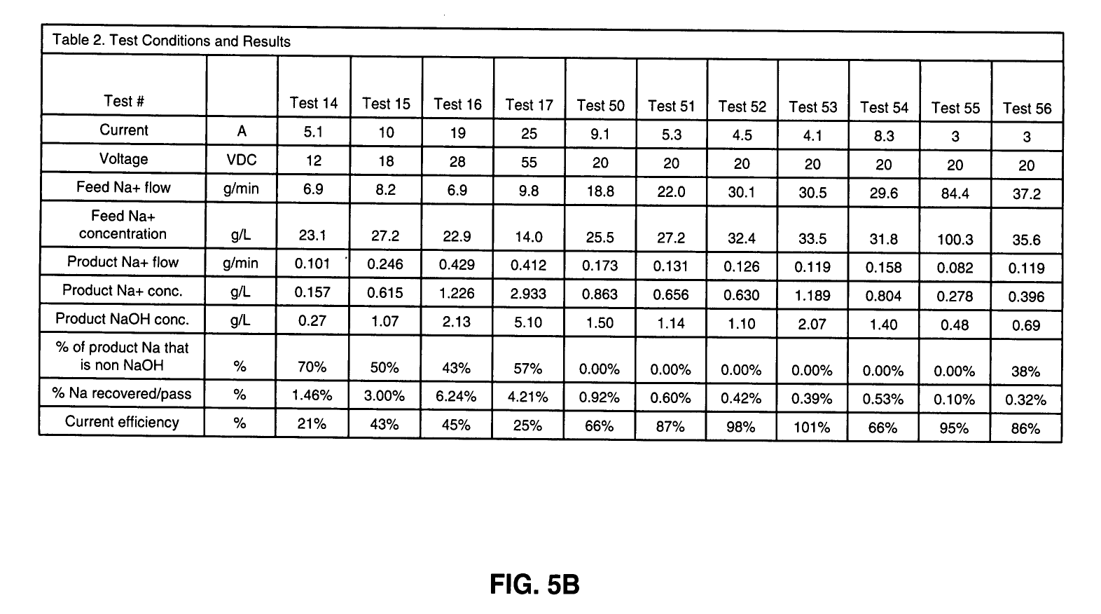

A summary table of the test conditions and results is shown in Tables 1 and 2 presented in FIGS. 5A and 5B, respectively. Test duration was the extent of time it took to record the parameters and collect samples, which was usually 1 to 5 minutes. The reported test time of day was recorded at the end of those steps.

The current efficiency is the fraction of the amperage that was utilized to transport sodium ions into the product NaOH stream. The current efficiency is calculated from Faraday's law, using the following equation.

$$current efficiency = \frac{{FZ}_{Na} {\dot{n}}_{Na}}{{An}_{2}}$$

Where, \dot{n}_{Na} is the molar flow rate of sodium in the product NaOH stream (mole Na/second); A is the electrical current (Amp); F is Faraday's constant (96,485 coulomb/mole); n₂ is the number of type 2 cells in the CEDI (in this case, two); Z_{Na} the charge of a sodium ion, which is +1.

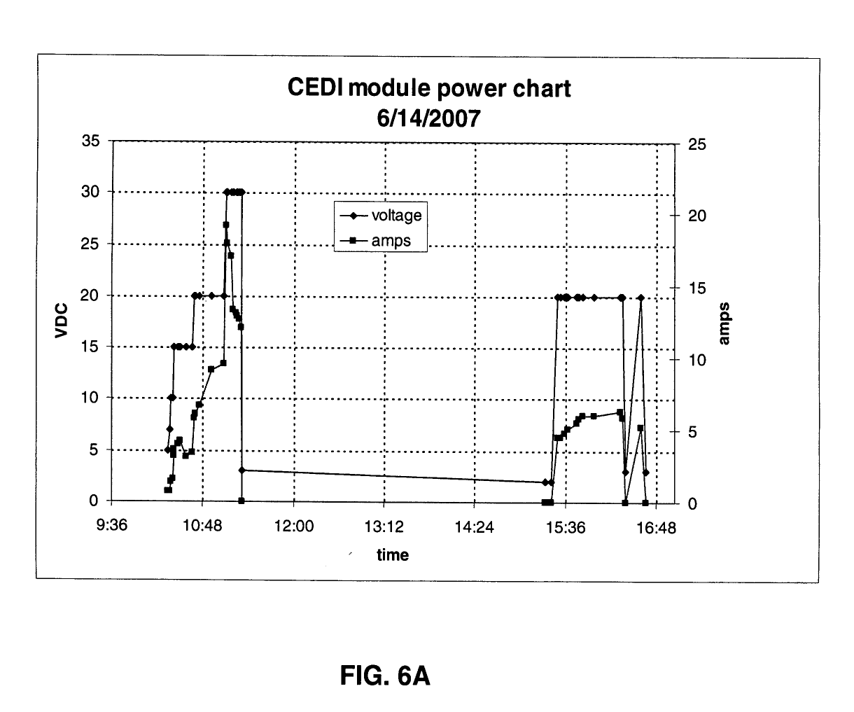

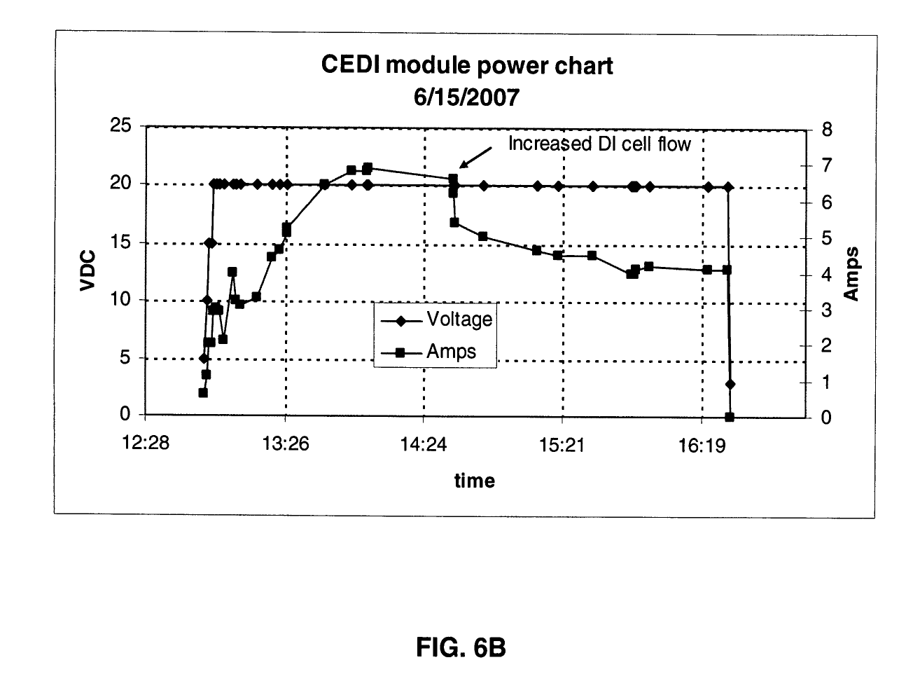

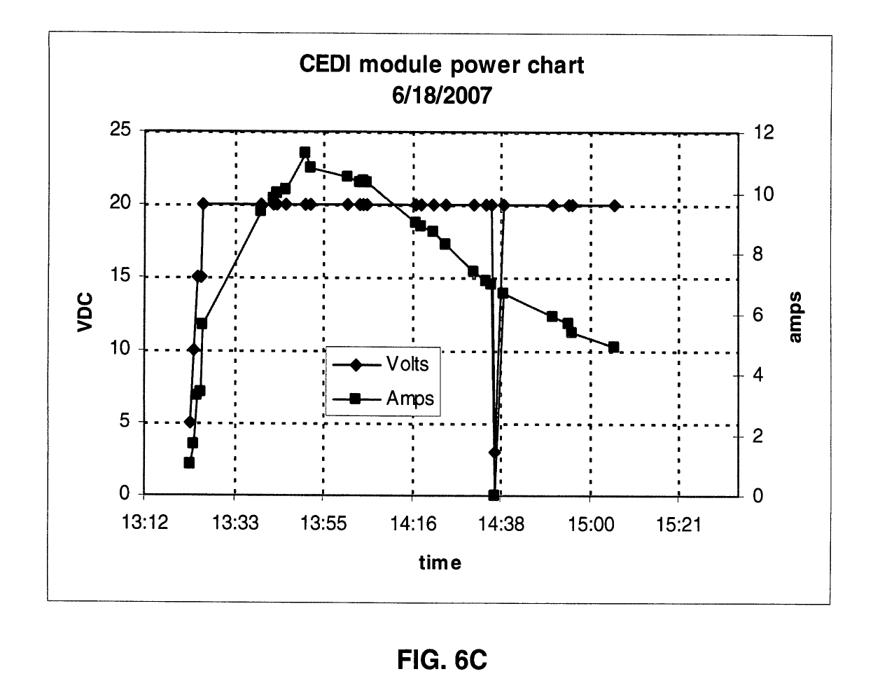

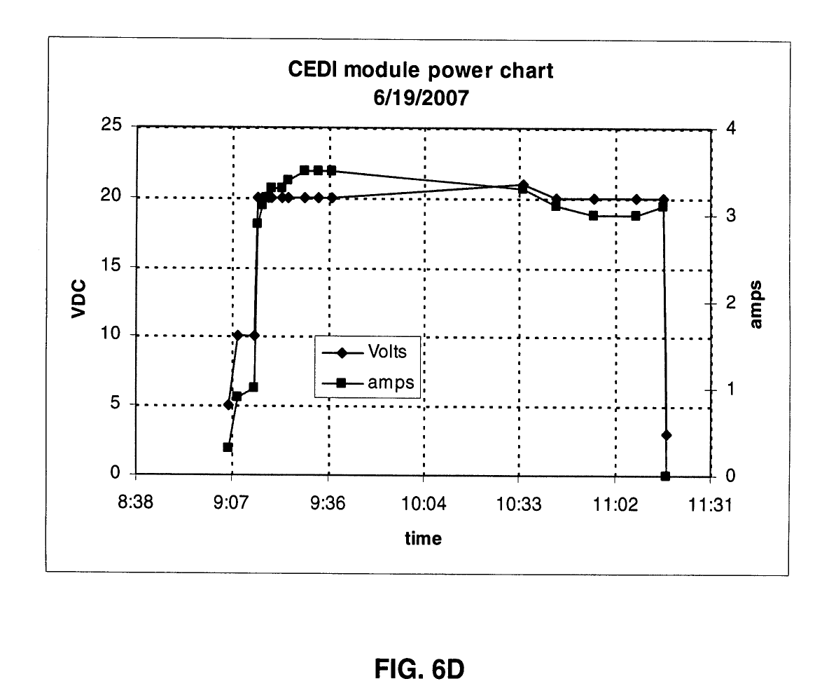

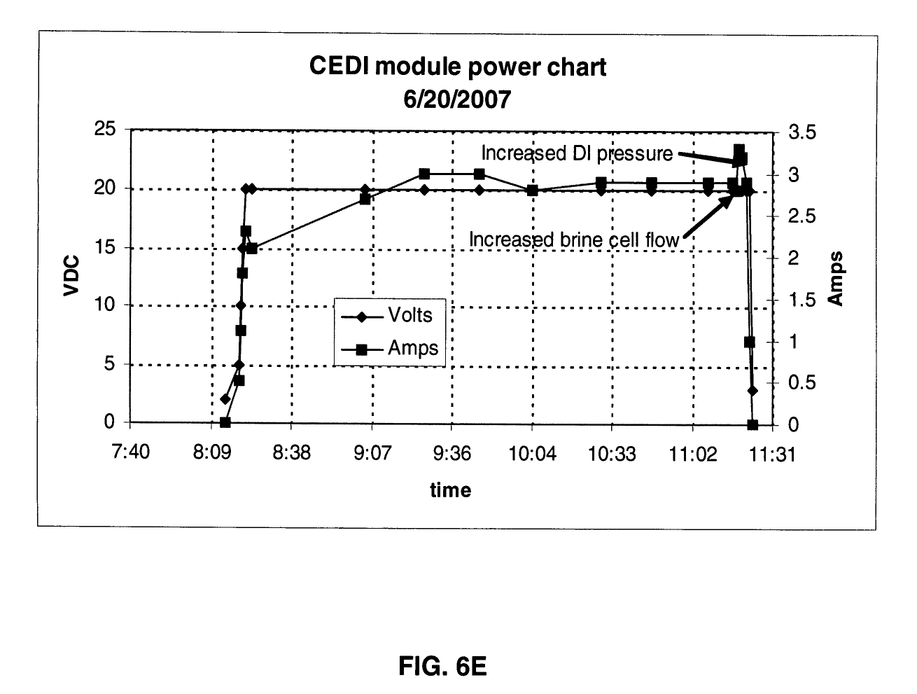

During some of the operations, power charts were recorded to monitor amperage as a function of voltage. These charts are shown in FIGS. 6A-6E. The power charts were recorded during sustained operations at the following nominal conditions as reported in Table 3:

TABLE 3

| | | | Outlet |
|---|---|---|---|
| | Flow rate | Inlet pressure | pressure |
| | (mL/min) | (psig) | (psig) |
| Cathode cell (brine - 1 cell) | 300 | 0 | 0 |
| Anode cell (brine - 1 cell) | 300 | 0 | 0 |
| Screen cell (brine - 1 cell) | 200 | 9 | 0.5 |
| DI outlet (DI feed - 2 cells) | 200 | 2.5 | 2 |
| Caustic outlet (DI Feed - 2 cells) | 200 | 2 | 1 |

At the conclusion of the test work, the module was disassembled. One of the membranes was analyzed by SEM. This membrane separated the brine in the cathode cell from the DI water in the resin bed cell.

### V. Discussion of Test Results

Effectiveness of the CEDI Process on Production of NaOH

All tests showed the CEDI process to be capable of extracting sodium ions from the brine and producing a stream of NaOH. The strength of NaOH in the product streams ranged from 0.14 to 8 g/L NaOH. There was some contamination of the product NaOH, either by carbonates, sulfates, or both. The purity of the NaOH in the product stream ranged from 30 to 100% pure. The source of contamination may be due to membrane leakage, either from damage or from porosity (see below).

Effect of Increased Amperage

Tests 3, 4, and 5 were identical tests performed at identical conditions, with increased electrical current with each test. The percent Na recovery and the concentration of Na in the product stream increased with increasing current. The effluent temperature also increased. The current efficiency decreased with increasing current. Decreasing current efficiency results in inefficient utilization of power and results in temperature increase.

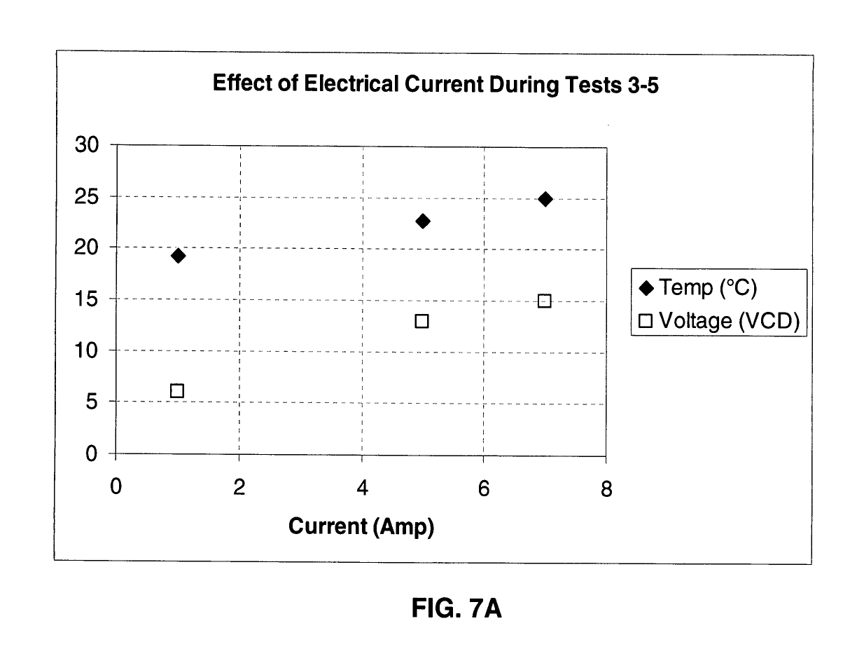

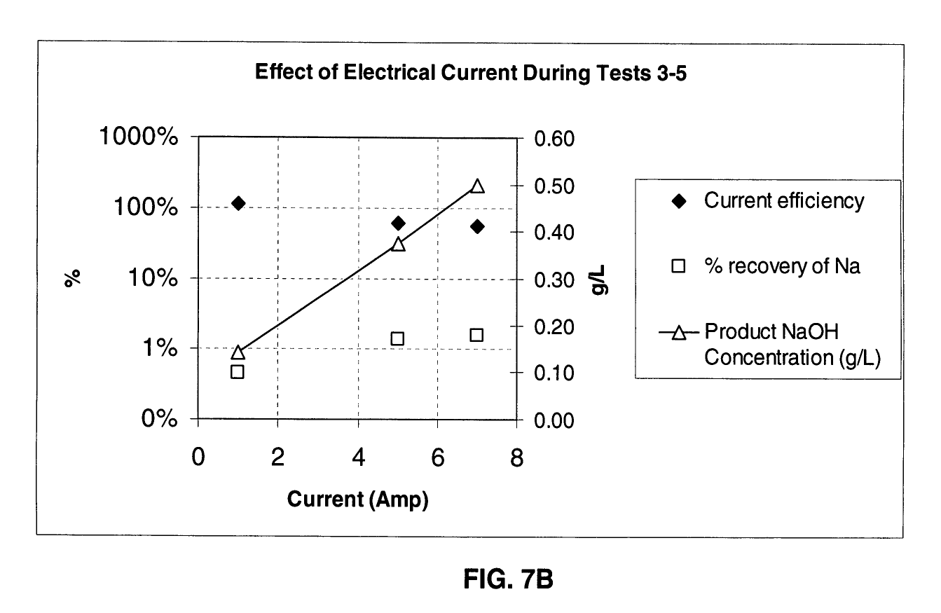

Results are shown graphically in FIGS. 7A and 7B.

During tests 14-57, operated at higher current, it was observed that the high amperage caused a loss of performance with time. This is shown in FIGS. 6A-6E, which shows the dynamic behavior of the current at high voltage. FIG. 6C shows upon unit start-up the amperage initially increased with time. This was due to NaOH formation in the product cell, which increased conductivity and thus amperage at fixed voltage. At approximate 13:50 the current reached a maximum at 11 amps. After this, current steadily declined.

The system was subsequently designed with independently controlled flow and pressure to suspect cells in order to reduce or eliminate potential vapor locking, where formed H₂, O₂, and CO₂ gases might be collecting in stationary bubbles which grow with time. Also, sodium carbonate was substituted as the feed in order to reduce or eliminate CO₂ gas production from Na⁺ removal. Loss of current with time was observed. The high current may have affected the surface of the membrane on the DI side.

Effect of Caustic Flow Rate

Tests 11 and 12 were performed with similar feed and amperage. In these tests the NaOH product stream was recycled through cell type 2. Product NaOH exited the system through a small purge stream, which was replenished by DI water (i.e. feed and bleed). In this way, the flow rate of the stream across the cell was maintained high, but the overall residence time was increased to produce a smaller flowing stream of higher strength product.

Test 12 had a higher product discharge rate, and thus shorter caustic retention time. These tests were otherwise identical. The shorter retention time resulted in a weaker NaOH product stream, however the % Na recovery was 4 times higher than in test 11 and the current efficiency was also higher. These results imply longer caustic residence time can increase the strength of product, but may reduce overall Na recovery and electrical efficiency. This may be due to the high osmotic pressure of the caustic stream resisting transport of more Na⁺ ions and may be overcome by using higher current.

Effect of Brine Concentration

Test 13 was conducted at similar conditions to 12, but with a lower strength feed brine. Test 13 was performed with carefully controlled differential pressure between cells, in an attempt to minimize cell/cell leakage. Test 13 was also conducted at a lower product discharge rate from cell type 2, in which a lower current efficiency and sodium recovery was expected prior to conducting this test. Surprisingly, this test showed better current efficiency and higher % Na recovery than test 12. It appears that using a weaker strength feed brine enhanced the sodium recovery.

Resin Effect

Test 7 was performed at similar conditions to test 4. Test 4 had a resin filled feed cell in the middle of the CEDI, while in test 7, this middle cell was filled with a screen. Test 7 feed was a higher strength feed, which would also have had an impact on results, making review difficult, since two parameters are different. However, based on the test 13 analysis, the higher strength feed brine was expected to produce a lower current efficiency, however in the test 7 to test 4 comparison, the current efficiency is surprisingly approximately the same. This implies that replacing the resin with a screen does not diminish the efficiency of the process. All subsequent tests were performed with screens in the brine cells.

Membrane Discussion

A homogeneous membrane was used during tests 14-16. These tests had the highest extent of contamination of the product. It is unclear if this was due to porosity/diffusion, or if there was a tear in the membrane.

Effect of Increasing Brine Flow Rate

Tests 8 and 12 were similar tests. Test 8 was conducted with higher brine and caustic flow rates than test 12. The current efficiency of test 8 was higher than 12 and the product caustic strength was similar. These results may indicate that the higher flow rate of brine increases efficiency.

Off-Gas Discussion

The process produced an off-gas in the brine recycle line. The off-gas formation rate and composition was not measured. By visual inspection, there was a significant gas flow in the return line which increased amperage. The gas comprised primarily hydrogen and oxygen, formed on the electrodes. CO₂ gas also evolved in tests that had NaHCO₃ in the feed, but no Na₂CO₃.

Scanning Electron Microscope (SEM) Results

Numerous different cell packs were tested in this evaluation. After the last test was complete, the last cell pack was cut open and samples of the membranes were retained. The cationic membrane separating the cationic cell from the DI water cell was dried, gold sputtered, and placed in an SEM for analysis. Each side of the membrane was analyzed, and results are shown in FIGS. 7A and 7B. The brine side image shows what appears to be resin particles suspended in the polyethylene sheet matrix. The cavities are larger than the particles, which is to be expected since the particles shrunk during the drying process, which was necessary in the sample preparation for the SEM. The DI water side shows similar, however it appears that the sheet matrix is different and may indicate damage.

DI Water Discussion

Over the course of tests 17-57, adjustments to the DI water were observed to cause an effect. At constant conditions, increasing DI water flow rate decreased the current (FIG. 6B). Similarly, increasing the relative pressure of the DI caused a decrease in current. Related to this, in some cases it was observed that increasing the brine pressure or flow would increase current (FIG. 6E). The decrease in current may be a result of a water splitting reaction producing H⁺ and OH⁻ ions in solution and in the resin bed. This may increase conductivity, and at higher DI water flow rate, these ions are washed out, decreasing conductivity. Alternatively, or in conjunction with water splitting, the ions from the brine and caustic cells may leak through the membranes into the DI water cell, which increases conductivity. Similarly, increasing DI water flow may wash out these ions more quickly. Increasing relative DI water pressure generally decreases the leak rate. Leaks may not easily be detected, however, since by the time the DI water is discharged, contaminant ions are removed by the CEDI process.

### VI. Results

The efficacy of CEDI for recovering Na⁺ as NaOH from oxidized spent caustic has been proven. Higher recovery, such as 10% Na is achievable by using a recycle. High amperage may be needed in order to produce high strong caustic at desirable flow-rates.

### PROPHETIC EXAMPLES

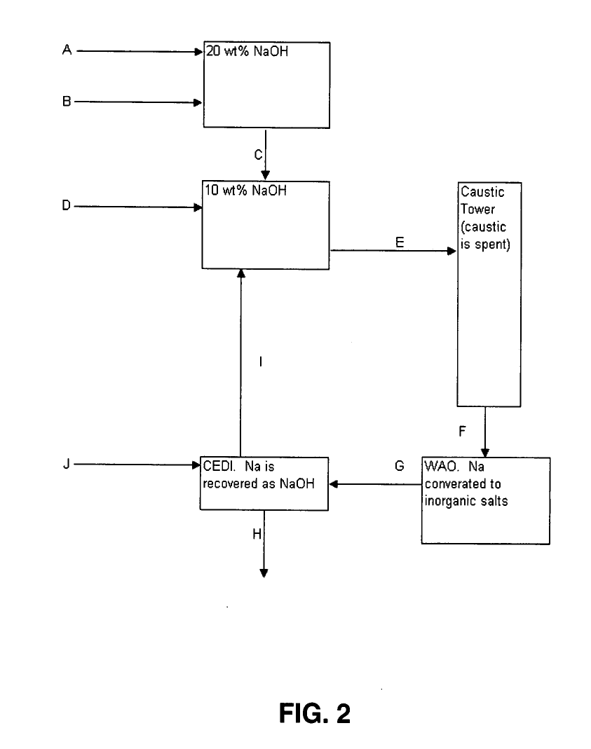

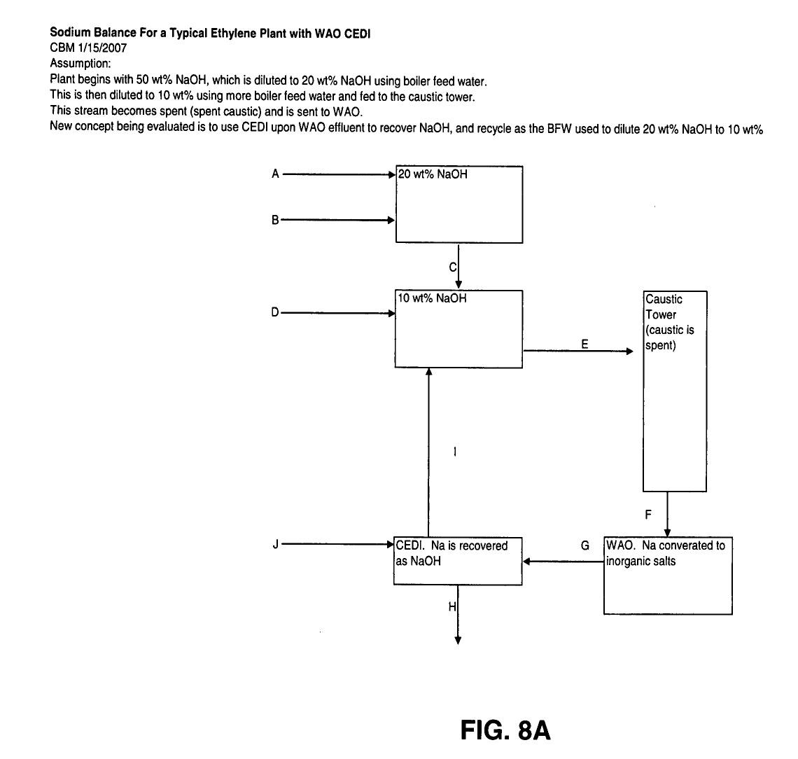

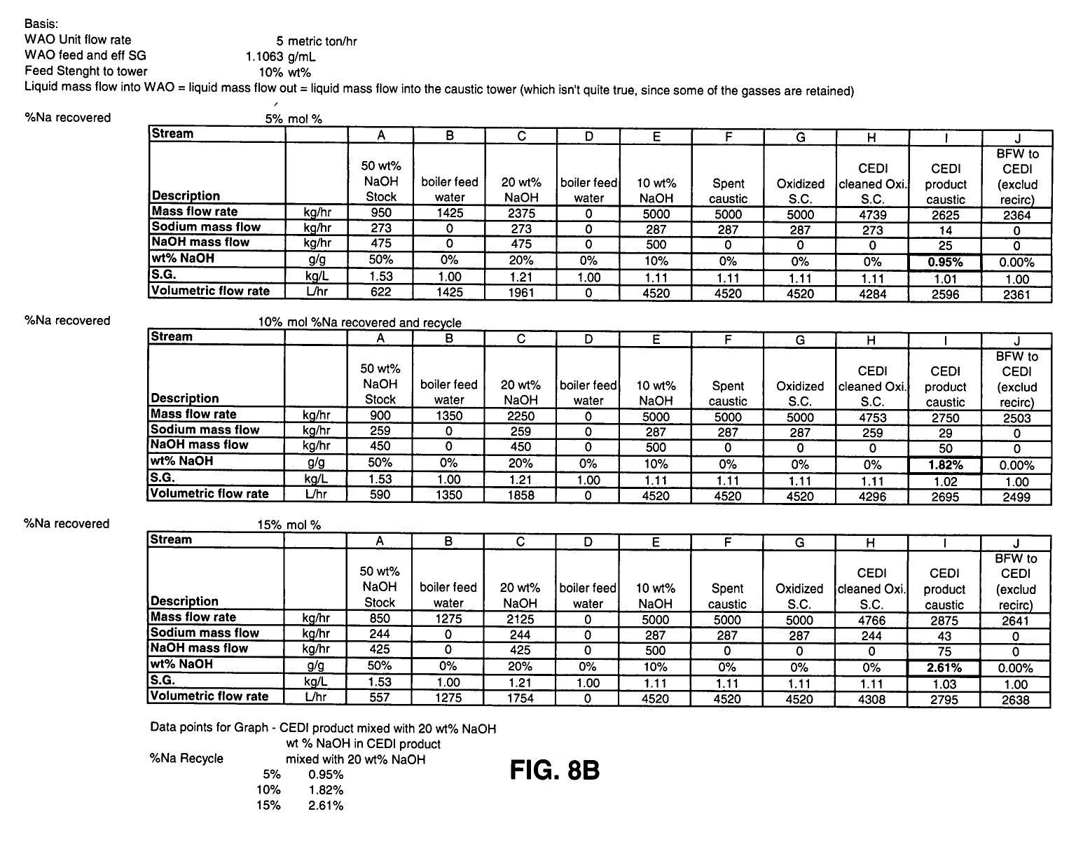

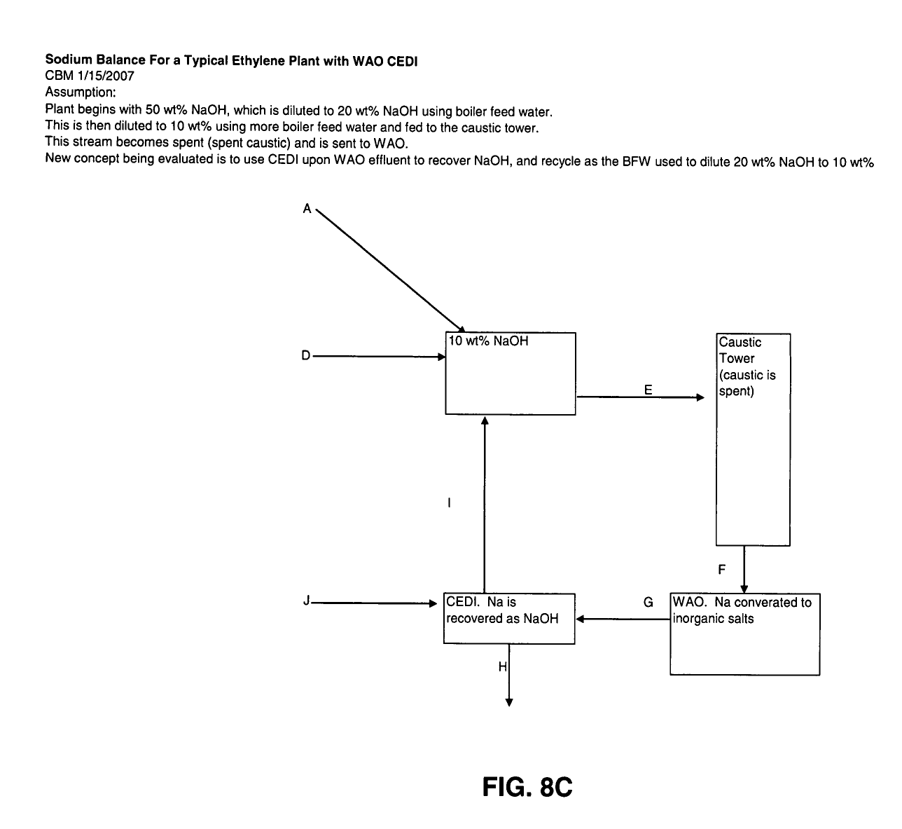

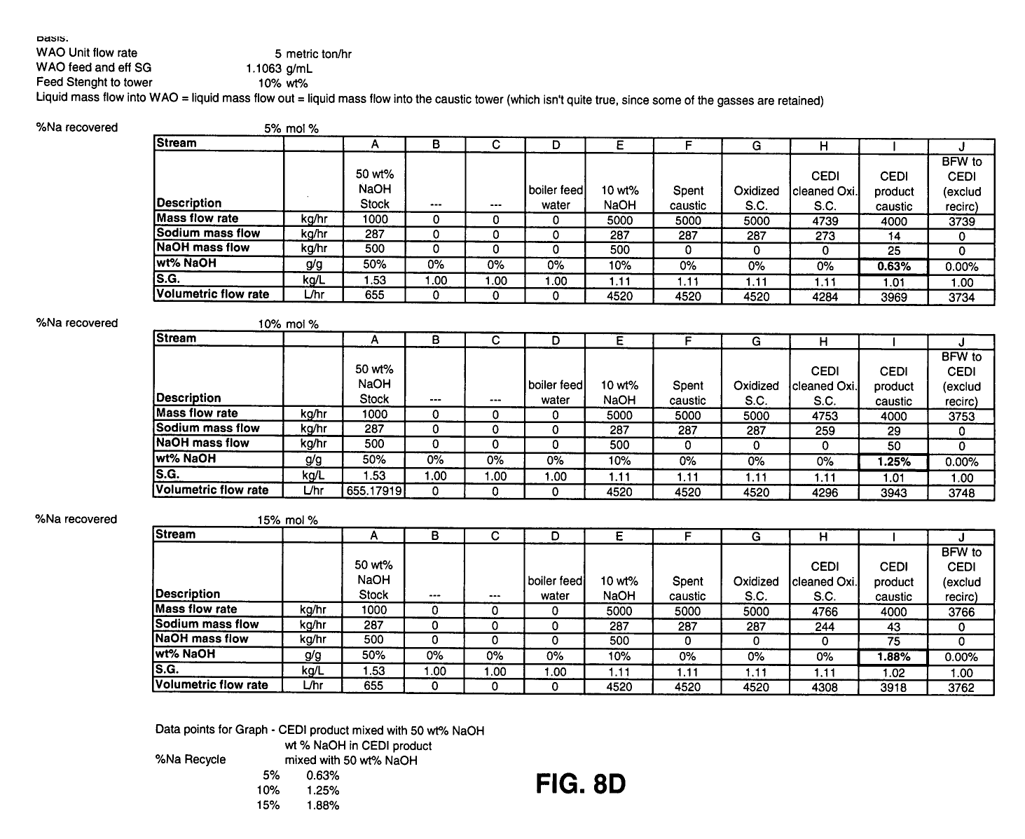

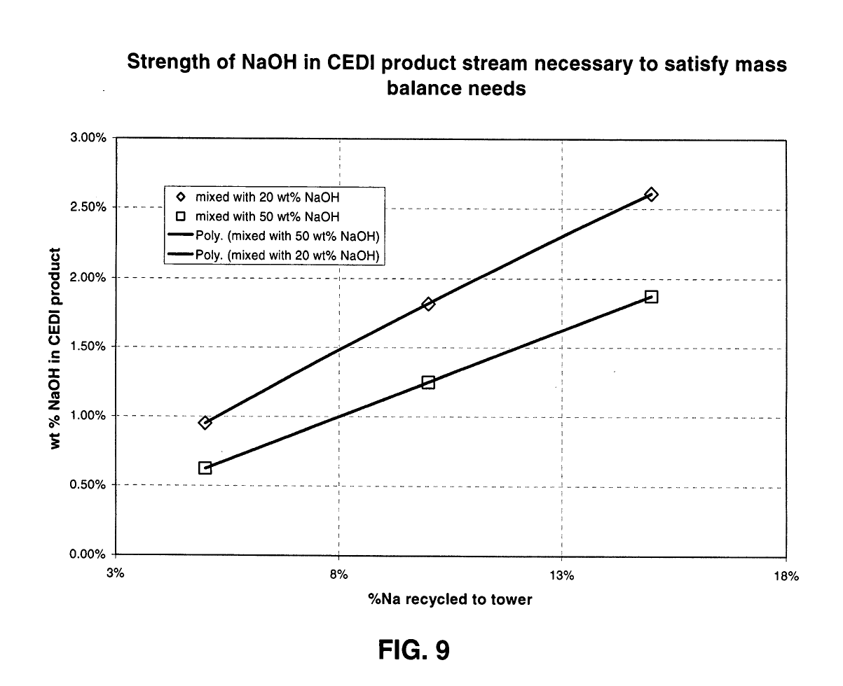

The perceived plant flow diagram (PFD) for an ethylene plant is shown in FIG. 2. Table 4 shows the mass balance for a plant where about 10% of the Na is recycled. In this example, the product NaOH from the CEDI unit will be about 1.8 wt % NaOH at a flow of about 55% of the total spent caustic flow. Balances for several different configurations are shown in FIGS. 8A-8D. FIG. 9 illustrates strength of NaOH in CEDI product stream to satisfy mass balance needs, such as may be based on similar balances.

TABLE 4
Sodium Balance for an Ethylene Plant with 10 wt % NaOH Tower Feed and 10% Recovery of Na

| | Stream | | | | | | | | | |
|---|---|---|---|---|---|---|---|---|---|---|
| | A | B | C | D | E | F | G | H | I | J |
| Description | 50 wt % | boiler | 20 wt % | boiler | 10 wt % | Spent | Oxidized | CEDI | CEDI | BFW |
| | NaOH | feed | NaOH | feed | NaOH | caustic | S.C. | cleaned | product | to CEDI |
| | Stock | water | | water | | | | Oxi. | caustic | (exclud |
| | | | | | | | | S.C. | | recirc) |
| Mass flow | 900 | 1350 | 2250 | 0 | 5000 | 5000 | 5000 | 4753 | 2750 | 2503 |
| rate | | | | | | | | | | |
| Sodium | 259 | 0 | 259 | 0 | 287 | 287 | 287 | 259 | 29 | 0 |
| mass flow | | | | | | | | | | |
| NaOH mass | 450 | 0 | 450 | 0 | 500 | 0 | 0 | 0 | 50 | 0 |
| flow | | | | | | | | | | |
| wt % NaOH | 50% | 0% | 20% | 0% | 10% | 0% | 0% | 0% | 1.82% | 0.00% |
| S.G. | 1.53 | 1.00 | 1.21 | 1.00 | 1.11 | 1.11 | 1.11 | 1.11 | 1.02 | 1.00 |
| Volumetric | 590 | 1350 | 1858 | 0 | 4520 | 4520 | 4520 | 4296 | 2695 | 2499 |
| flow rate | | | | | | | | | | |

Having thus described several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A system for treating an aqueous feed, comprising:
an oxidation unit fluidly connected to a source of the aqueous feed; and
a demineralization unit fluidly connected downstream of the oxidation unit, constructed and arranged to convert a product of the oxidation unit to a target compound.

2. The system of claim 1, wherein the aqueous feed comprises at least one sodium-based compound.

3. The system of claim 1, wherein the aqueous feed comprises at least one organic compound.

4. The system of claim 1, wherein the aqueous feed comprises at least one sulfide compound.

5. The system of claim 2, wherein the product of the oxidation unit comprises at least one of sodium carbonate and sodium sulfate.

6. The system of claim 1, wherein the oxidation unit comprises a liquid phase oxidation unit.

7. The system of claim 6, wherein the oxidation unit comprises a wet air oxidation unit.

8. The system of claim 6, wherein the liquid phase oxidation unit comprises a supercritical water oxidation unit.

9. The system of claim 6, wherein the oxidation unit comprises a catalyzed oxidation unit.

10. The system of claim 1, wherein the oxidation unit comprises a peroxide, permanganate, ultraviolet or visible light oxidation unit.

11. The system of claim 1, wherein the demineralization unit comprises at least one ion exchange resin bed.

12. The system of claim 1, wherein the demineralization unit comprises an electrochemical deionization unit.

13. The system of claim 12, wherein the electrochemical deionization unit is an electrodialysis, electrodialysis reversal, capacitive deionization, electrodeionization, continuous electrodeionization or reverse continuous electrodeionization unit.

14. The system of claim 13, wherein the electrochemical deionization unit is a continuous electrodeionization unit.

15. The system of claim 1, wherein the target compound is a caustic.

16. The system of claim 15, wherein the caustic comprises sodium hydroxide.

17. The system of claim 15, wherein the caustic comprises ammonium sulfate.

18. The system of claim 15, wherein the caustic is not present in the oxidation unit product.

19. The system of claim 1, further comprising a concentrator fluidly connected downstream of the demineralization unit.

20. The system of claim 1, wherein the source of the aqueous feed is an industrial operation.

21. The system of claim 20, wherein the source of the aqueous feed is an ethylene production facility.

22. The system of claim 20, wherein an outlet of the demineralization unit is fluidly connected to the industrial operation.

23. The system of claim 1, further comprising a controller in communication with at least one of the oxidation and demineralization units.

24. The system of claim 23, further comprising a sensor in communication with the controller, configured to detect a characteristic of a demineralization effluent stream.

25. The system of claim 24, wherein the controller is constructed and arranged to adjust one or more process conditions of at least one of the units in response to a detected characteristic of the demineralization effluent stream.

26. The system of claim 1, further comprising a polishing unit fluidly connected downstream of the demineralization unit.

27. The system of claim 26, wherein the polishing unit comprises a biological treatment unit.

28. The system of claim 14, wherein the continuous electrodeionization device comprises at least one homogeneous membrane.

29. The system of claim 7, wherein the demineralization unit comprises a continuous electrodeionization unit.

30. The system of claim 29, wherein the target compound comprises sodium hydroxide.

31. A system for treating an aqueous feed containing a spent caustic, comprising:
an oxidation unit fluidly connected to a source of the aqueous feed; and
an electrochemical deionization unit fluidly connected downstream of the oxidation unit, constructed and arranged to generate a fresh caustic.

32. The system of claim 31, wherein the oxidation unit comprises a wet air oxidation unit.

33. The system of claim 31, wherein the electrochemical deionization unit comprises a continuous electrodeionization unit.

34. The system of claim 33, wherein the system is configured to recycle an effluent stream to the electrochemical deionization unit.

35. The system of claim 31, wherein the fresh caustic comprises sodium hydroxide.

36. The system of claim 31, wherein the source of the aqueous feed is an ethylene production facility.

37. A method of treating an aqueous stream, comprising:
oxidizing the aqueous stream to form an oxidation product; and
converting the oxidation product to form a caustic stream.

38. The method of claim 37, wherein the caustic stream comprises sodium hydroxide.

39. The method of claim 38, further comprising providing the caustic stream to an industrial operation.

40. The method of claim 37, wherein oxidizing the aqueous stream comprises oxidizing the aqueous stream at a temperature of at least about 150° C.

41. The method of claim 37, wherein converting the oxidation product comprises isolating a target ion from the oxidation product.

42. The method of claim 41, wherein converting the oxidation product further comprises associating the isolated target ion with a regeneration fluid to form the caustic stream.
